(19) United States
(12) Patent Application Publication
(10) Pub. No.: US 2002/0013806 A1
(43) Pub. Date: Jan. 31, 2002

(54) Mobile internet

(76) Inventor: Paraskevas Dunias, Eindhoven (NL)

Correspondence Address: Jack E. Haken, U.S. Philips Corporation, 580 White Plains Road, Tarrytown, NY, 10591, US

(21) Appl. No.: 09/835,631

(22) Filed: Apr. 16, 2001

(30) Foreign Application Priority Data
Apr. 18, 2000 (EP) 00201373.8

(51) Int. Cl. G06F 15/16

(52) U.S. Cl. 709/201

(57) ABSTRACT

Portable computers are known in the art and are used to make working at different places possible.

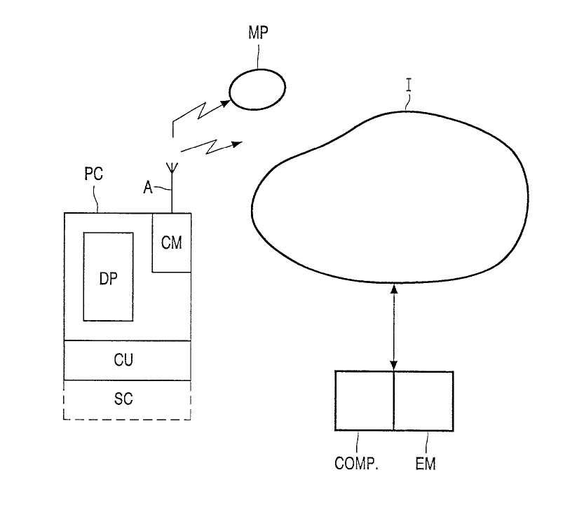

To improve the possibilities to use a portable computer wherever the user is the invention propose a portable computer having means to couple the computer to the internet via a mobile telephone connection.

In this way it is made possible to use the portable computer wherever the user is without the need to connect the portable computer to the central computing network or via cables to a telephone network.

The invention relates to a portable computer as described in the preamble of claim 1.

Portable computers are known in the art and are more and more used by all kind of peoples who are no longer working on one place but are in stead besides working in an office also working at home, or when abroad in a hotel etc.

A disadvantage of this known portable computer is that this portable computer has to be connected to either a central computing system or via a cable to the telephone warriors.

An object of the invention is to provide a portable computer, which has not the disadvantages of the prior art portable computers. To this end a portable computer according to the invention comprises the features of claim 1.

In this way it is possible to use the portable computer as a separate unit without needing to couple this portable computer to either a central computer network or with cables to the telephone network. A further advantage of this portable computer is that now it is made possible to really work on the place the user wants to work not needing to connect the computer via cables etc. he now is really in the position to work for example in the train, a car, at home, in the garden, etc. It to be noticed here that the not pre-published American patent application Ser. No. 09/427821 describes a remote control which can be used regardless of the distance between the equipment to be controlled and the user.

Embodiments of the invention are described in the dependent claims. The invention and additional features which may optionally be used to implement the invention to advantage will be apparent from and elucidated with reference to the examples described below and hereinafter and shown in the figure. Herein shows:

The FIGURE a schematic embodiment of a portable computer according to the invention.

The FIGURE shows schematically an example of a portable computer PC according to the invention comprising a calculation unit CU, a display DP and coupling means CM having an antenna A. The portable computer PC can be coupled to the internet I via a mobile telephone connection and can be coupled to other computers COMP and communicate via email EM.

The portable computer PC can also be used as a mobile phone via de coupling means CM and the antenna A to a mobile phone network MP. The mobile phone network MP and the internet I as shown as two separate elements in the figure can also be coupled into one net.

The portable computer PC can also have battery means coupled to solar cells SC to make the portable computer independent from charging the batteries.

As the portable computer will be used to be coupled to the internet via an internet browser to an internet provider the portable computer can be made for example as small as an A4-paper and only a few centimeters fig.

To improve the ease of use it is for example possible that the portable computer automatically connects to the internet and automatically starts the internet browser. In this way the user can start immediately without knowing anything about starting an internet browser making a connection installation etc.

Further by making the portable computer as small as an A4-paper it is easy for the user to carry the portable computer with him wherever he goes and use this portable computer at each place he likes to use the portable computer.

It will be noticed that above the portable computer according to the invention has been described as an example and that the portable computer can be amended without departing from the main idea of the invention.

By combining the portable computer with the mobile phone it is really made possible to use the portable computer wherever the user is in stead of the portable computers as are available until now where it is necessary to connect the portable computer to either a central computing network or with cables to a telephone network, etc.

1. A portable computer comprising a calculation unit and a display, characterized in that the portable computer comprises means to couple the computer to the internet via a mobile telephone connection.

2. A portable computer as claimed in claim 1, characterized in that the portable computer comprises a modem.

3. A portable computer as claimed in claim 1, characterized in that the portable computer comprises a battery means coupled to solar cells.

4. A portable computer as claimed in claim 1, characterized in that the portable computer comprises means to use to portable computer as a mobile phone.
